(19) United States
(12) Patent Application Publication
(10) Pub. No.: US 2026/0085765 A1
(43) Pub. Date: Mar. 26, 2026

(54) VALVE APPARATUS OPERATED WITH A HIGH PRESSURE MOTIVE FLUID AND METHOD OF OPERATING THE SAME

(71) Applicant: Dallas Chism Watson, Guthrie, OK (US)

(72) Inventor: Dallas Chism Watson, Guthrie, OK (US)

(21) Appl. No.: 19/337,432

(22) Filed: Sep. 23, 2025

Related U.S. Application Data
(60) Provisional application No. 63/697,662, filed on Sep. 23, 2024.

(51) Int. Cl. F16K 31/122; E21B 34/02; E21B 34/08

(52) U.S. Cl. CPC F16K 31/1221; F16K 31/1223; E21B 34/025; E21B 34/08

(57) ABSTRACT

A valve apparatus for controlling the flow of fluid. The valve apparatus includes a valve having a valve body, a valve inlet for allowing fluid to flow into the valve body, and a valve outlet for allowing fluid to flow out of the valve body. The valve apparatus also includes a rod element that selectively engages the valve to permit fluid to flow from the valve inlet to the valve outlet and a valve actuation apparatus to apply force to the rod element to open and close the valve. Additionally, the valve apparatus includes a spring disposed within the valve actuation apparatus for applying force to the rod element in a certain direction, the spring having a pressure force. The valve apparatus can also include a switch valve for selectively directing a high-pressure motive fluid to the valve actuation apparatus and for directing an operational fluid to the valve actuation apparatus. A method of opening a closing a valve includes directing a high-pressure motive fluid and an operational fluid to a valve apparatus to open and close a valve. The operational fluid is taken from a contained pressurized system. Additionally, the method includes exhausting the operational fluid from the valve apparatus back into the contained pressurized system under a pressure greater than about 30 psi.

### STATEMENT REGARDING FEDERALLY SPONSORED RESEARCH OR DEVELOPMENT

Not applicable.

### CROSS-REFERENCE TO RELATED APPLICATIONS

The present application is a conversion of U.S. Provisional Application having U.S. Ser. No. 63/697,662, filed Sep. 23, 2024, which claims the benefit under 35 U.S.C. 119(e). The disclosure of which is hereby expressly incorporated herein by reference.

### BACKGROUND OF THE DISCLOSURE

### 1. Field of the Invention

The present disclosure generally relates to a valve apparatus that can be pneumatically actuated using a high pressure motive fluid.

### 2. Description of the Related Art

During the production, transportation and processing of natural gas and oil, it is common practice to utilize readily available compressed natural gas to operate pneumatic actuated valves. These valves are typically operated by applying gas pressure to a single side of a diaphragm located within a chamber. Gas pressure is then released from the chamber allowing a spring to return the diaphragm to its original open or closed position. This release of gas is typically vented and/or exhausted to the atmosphere and/or to low pressure piping and/or vessels. Exhausting and/or venting these types of valves into a pressurized system is limited to the spring return strength and diaphragm strength which limits the exhaust pressure into a contained environment.

Accordingly, there is a need for a valve apparatus that can be operated by high pressure motive fluids that can also be returned back into a contained system at higher pressures that what can be achieved with a diaphragm.

### SUMMARY OF THE DISCLOSURE

The present disclosure is directed to a valve apparatus for controlling the flow of fluid. The valve apparatus includes a valve having a valve body, a valve inlet for allowing fluid to flow into the valve body, and a valve outlet for allowing fluid to flow out of the valve body. The valve apparatus also includes a rod element that selectively engages the valve to permit fluid to flow from the valve inlet to the valve outlet and a valve actuation apparatus to apply force to the rod element to open and close the valve. Additionally, the valve apparatus includes a spring disposed within the valve actuation apparatus for applying force to the rod element in a certain direction, the spring having a pressure force. The valve apparatus can also include a switch valve for selectively directing a high-pressure motive fluid to the valve actuation apparatus and for directing an operational fluid to the valve actuation apparatus.

The present disclosure is also directed to a method of opening a closing a valve using a high-pressure motive fluid. The method includes directing a high pressure motive fluid to a valve apparatus to open and close a valve. The method also includes directing an operation fluid to a valve apparatus to contribute to the opening and closing of the valve, the operational fluid taken from a contained pressurized system. Additionally, the method includes exhausting the operational fluid from the valve apparatus back into the contained pressurized system under a pressure greater than about 30 psi.

### BRIEF DESCRIPTION OF THE DRAWINGS

FIG. 1 is a schematic view of one embodiment of a system using a valve apparatus constructed in accordance with the present disclosure.

FIG. 2 is a perspective view of the valve apparatus constructed in accordance with the present disclosure.

FIGS. 3A-3B are partial cross-sectional view/partial side elevation views of the valve apparatus constructed in accordance with the present disclosure.

FIG. 4 is a schematic view of another embodiment of a system using another embodiment of a valve apparatus constructed in accordance with the present disclosure.

FIG. 5 is a perspective view of the other embodiment of the valve apparatus constructed in accordance with the present disclosure.

FIGS. 6A-6B are partial cross-sectional view/partial side elevation views of the valve apparatus of FIG. 5 and constructed in accordance with the present disclosure.

### DETAILED DESCRIPTION OF THE DISCLOSURE

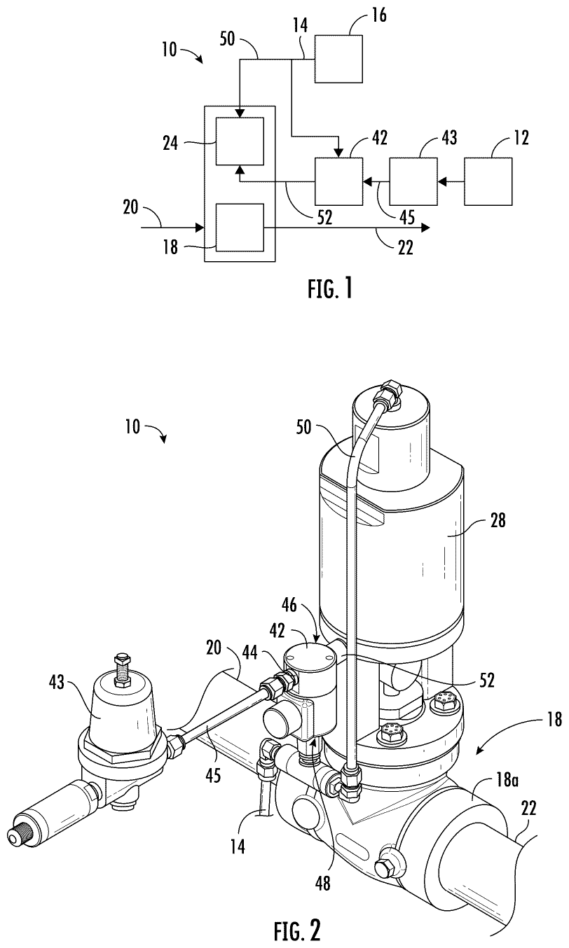

Referring now to FIGS. 1-6, the present disclosure is related to a valve apparatus 10 for controlling the flow of a production fluid, such as a liquid or a gas, that can be opened and closed using a high-pressure motive fluid from a high-pressure motive fluid source 12 and an operational fluid in fluid communication with the valve apparatus 10 via an exhaust line 14. The exhaust line 14 delivering the operational fluid can be in fluid communication with a pressurized system 16 wherein the fluid of the pressurized system is maintained at a certain pressure range. For example, the pressurized system providing the operational fluid can be a flow line delivering production fluids from oil and gas wells. It should be understood that a fluid can be a liquid or a gas. The present disclosure is also directed to a method of using the high-pressure motive fluid and the operational fluid to operate (open and close) the valve apparatus 10. The high-pressure motive fluid can be a gas that is harmful to the environment, and it is preferred to prevent release of the gas into the atmosphere. Examples of these harmful gases include, but are not limited to, methane, natural gas, carbon dioxide, hydrogen sulfide, carbon monoxide, etc. The high-pressure motive fluid source 12 of one of these environmentally harmful gases could be found in various industrial settings. A typical source of one of these harmful gases could be natural gas produced from an oil and gas well. In another example, the high-pressure motive fluid source 12 can be the gas from the casing of an oil and gas well. It should be understood and appreciated that the high-pressure motive fluid and the operational fluid used to operate the valve apparatus 10 do so without being vented to the atmosphere.

Shown in FIGS. 2-3B and 5-6B, the valve apparatus 10 includes a valve 18 having a valve body 18a with an inlet 20 for receiving a production fluid (liquid or gas) to the valve body 18a and an outlet 22 for permitting the production fluid to exit the valve body 18a. The valve apparatus 10 can also include a valve actuation apparatus 24 for opening and closing the valve 18 to permit fluids to flow therethrough or to prohibit the flow of fluids therethrough. The valve actuation apparatus 24 can be linked to the valve 18 via a rod element 26. The rod element 26 has a first and second position in the valve body 18a. In the first position, the rod element 26 is engaged with a seat (not shown) to prevent flow of the production fluid through the valve body 18a. In the second position, the rod element 26 is disengaged from the seat and permits the production fluid to flow through the valve body 18a.

The rod element 26 can be shifted between the first and second positions by the valve actuation apparatus 24. In one embodiment, the valve actuation apparatus 24 includes a compression cylinder 28 with a piston 30 disposed therein that is connected to the rod element 26. Due to the connection between the rod element 26 and the piston 30, the rod element 26 moves between the first and second positions as the piston 30 is forced in a first direction and forced in a second direction. The compression cylinder 28 can have a first compression side 32 and a second compression side 34. The valve apparatus 10 can also include a spring 36 to provide an open or closing force on the rod element 26 to open or close the valve 18. The open or closing force from spring 36 can be directly or indirectly applied to the rod element 26. The pressure force of the spring 36 can be any pressure force desirable such that operation of the valve apparatus 10 operates as intended.

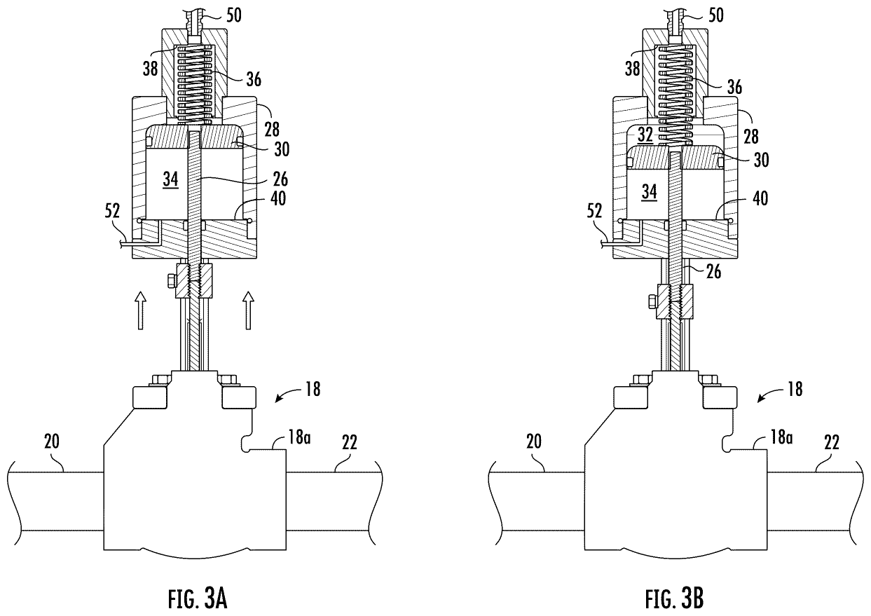

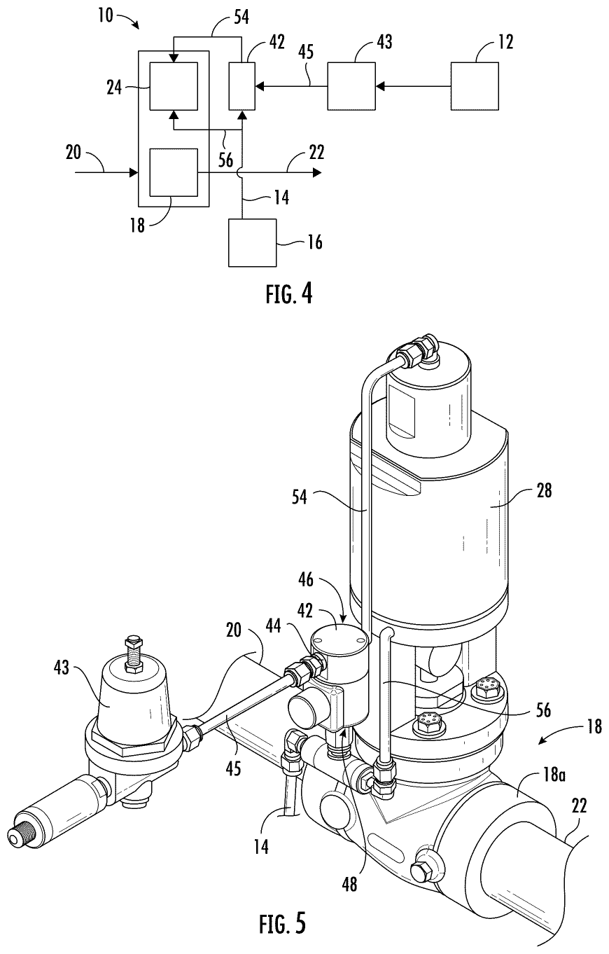

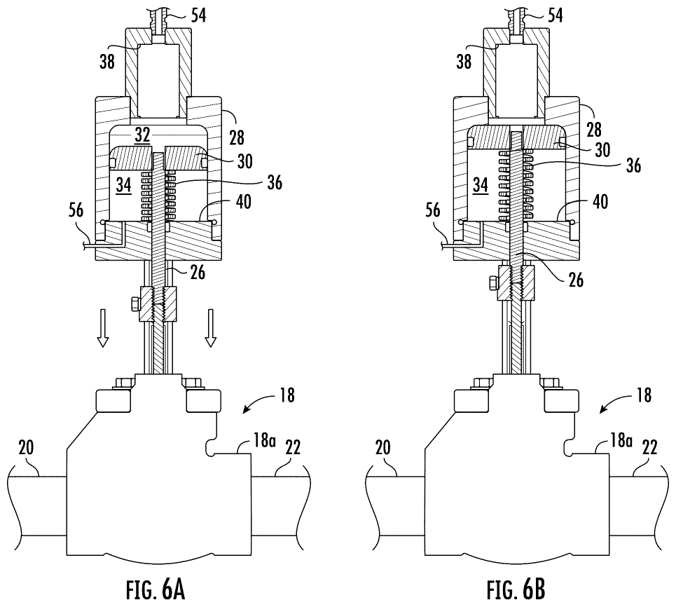

In one embodiment shown in FIGS. 2-3B, the spring 36 can be placed in the compression cylinder 28 on the first compression side 32 of the piston 30 and force the valve 18 closed. In this embodiment, the spring 36 can be disposed between a top portion 38 of the compression cylinder 28 and the piston 30. In another embodiment shown in FIGS. 5-6B, the spring 40 can be placed in the compression cylinder 28 on the second compression side 34 of the piston 30 to force the valve 18 open. In this embodiment, the spring 36 can be disposed between a bottom portion 40 of the compression cylinder 28 and the piston 30. In these embodiments, the spring 36 provides force directly to the piston 30 and indirectly to the rod element 26.

The valve actuation apparatus 24 can include a switch valve 42 (or latch valve) that can direct a high-pressure motive fluid from the high-pressure motive fluid source 12 to the compression cylinder 28 to open or close the valve 18 depending on the operational setup of the switch valve 42. The high-pressure motive fluid can be delivered to the switch valve 42 from a regulator 43 via a fluid delivery line 45. The regulator 43 maintains the high-pressure motive fluid at a desired pressure for operation of the valve apparatus 10. The switch valve 42 can have an inlet 44 for receiving the high-pressure motive fluid, a first outlet 46 in fluid communication with the first compression side 32 of the compression cylinder 28 and an inlet-outlet 48 in selective fluid communication with the second compression side 34 of the compression cylinder 28 via a first fluid line 50. The inlet-outlet 48 of the switch valve 42 can also be in fluid communication with the exhaust line 14. The switch valve 42 can designed to direct the high-pressure motive fluid to the desired compression side of the compression cylinder 28, or prohibit the high pressure motive fluid from being directed to the compression cylinder 28 at all. The switch valve 42, via the first outlet 46 and the inlet-outlet 48, can also allow for the first and second compression sides 32 and 34 of the compression cylinder 28 to be in fluid communication, which causes the pressure on both sides of the piston 30 to equalize. In this scenario, the operation fluid from the exhaust line 14 is directed to the first and second compression sides 32 and 34 of the compression cylinder 28. This equalization allows the spring 36 to be the determining force acting to open or close the valve.

When the valve is set up in a default close setup as shown in FIGS. 1-3B (i.e., when the spring force is directed to close the valve 18), the switch valve 42 directs the high pressure motive fluid to the second compression side 34 via a second fluid line 52 and directs the operational fluid to the first compression side 32 of the compression cylinder 28 via the inlet-outlet 48 of the switch valve 42 and the first fluid line 50. When the switch valve 42 directs the high-pressure motive fluid to the second compression side 34 of the piston 30, the piston 30 forces the rod element 26 in the direction shown by arrows (see FIG. 3A) and away from the seat to open the valve 18. To accomplish this, the high-pressure motive fluid has to have a pressure higher than the pressure force the spring 36 provides and the pressure of the operational fluid. When it is desirous for the valve 18 to be closed, a signal can be sent to the switch valve 42 to prevent the high-pressure motive fluid from flowing to the second compression side 34 of the compression cylinder 28. The switch valve 42 then directs the operational fluid to the first and second compression sides 32 and 34 of the compression cylinder 28 via the first fluid line 50 and the second fluid line 52, respectively, which permits the fluid in the first and second sides of the compression cylinder 28 to be in communication and reach equilibrium. The spring 36 will close the valve 18 when the pressure of the fluid in the first and second sides 32 and 34 of the compression cylinder 28 reach equilibrium (see FIG. 3B).

When the valve 18 is set up in a default open setup as shown in FIGS. 4-6B (i.e., when the spring force is directed to open the valve 18), the switch valve 42 directs the high pressure motive fluid to the first compression side 32 via a fluid passageway 54 and the outlet 22 of the switch valve 42. The operational fluid is directed by the latch valve 42 to the second compression side 34 of the compression cylinder 28 via a second fluid passageway 56 in fluid communication with the exhaust line 14. When the switch valve 42 directs the high-pressure motive fluid to the first compression side 32 of the piston 30, the piston 30 forces the rod element 26 in the direction shown by arrows (FIG. 6A) and toward the seat to close the valve 18. To accomplish this, the high-pressure motive fluid has to have a pressure higher than the pressure force the spring 36 provides and the pressure of the operational fluid, which is directed by the latch valve 42 to the second side 34 of the compression cylinder 28. When it is desirous for the valve 18 to be opened, a signal can be sent to the switch valve 42 to prevent the high-pressure motive fluid from flowing to the first compression side 32. The switch valve 42 then directs the operational fluid to the first and second compression sides 32 and 34 of the compression cylinder 28 via the first fluid passageway 54 and the second fluid passageway 56, respectively, which permits the fluid in the first and second sides of the compression cylinder 28 to be in communication and reach equilibrium. The spring 36 will open the valve 18 when the pressure of the fluid in the first and second sides of the compression cylinder 28 reach equilibrium (see FIG. 6B).

The valve apparatus 10 can also include a diverter (not shown) to direct the operational fluid from the exhaust line 14 to the latch valve 42 and first fluid line 50 or the second fluid passageway 56 depending on the operational set up of the valve apparatus 10 (i.e., fail open or fail closed set up). The exhaust line 14 is in fluid communication with the pressurized system 16 that provides the operational fluid. In addition to providing the operational fluid for operating the valve apparatus 10, the pressurized system 16 also collects the fluid/gas forced from the compression cylinder 28 when the high-pressure motive fluid is directed to the compression cylinder 28 to open or close the valve 18 depending on how the valve apparatus 10 is set up. For example, when the valve 18 is set up in the default closed set up, the exhaust line 14 is in fluid communication with the first fluid line 50 because the motive fluid is forced into the second compression side 34 of the compression cylinder 28 forcing an exhaust gas (or spent operational fluid) out of the first compression side 32 of the compression cylinder 28. The motive fluid is set at such a pressure (via the regulator 43) that it overcomes the pressure force of the spring 36 and the pressure of the operational fluid to force the exhaust gas back into the first fluid line 50, the exhaust line 14 and ultimately back into the pressurized system 16. Alternatively, when the valve 18 is set up in the default open set up, the exhaust line 14 is in fluid communication with the second fluid passageway 56 because the motive fluid is forced into the first compression side 32 of the compression cylinder 28 forcing the exhaust gas out of the second compression side 34 of the compression cylinder 28. In this set up, the exhaust gas in the compression cylinder 28 is forced back into the second fluid passageway 56, the exhaust line and ultimately back into the pressurized system 16.

The pressurized system 16 and the operational fluid can have its own pressure threshold and be part of a contained system or environment. Therefore, the motive fluid has to have a pressure that is strong enough to overcome the force of the spring 36 and the pressure of the operational fluid and the pressurized system 16, which can be a vent line, vessel or any type of apparatus capable of receiving the exhaust gas that can be part of the contained environment or system. In one embodiment, the high-pressure motive fluid can be greater than about 50 psi. In another embodiment, the high-pressure motive fluid can be greater than about 75 psi. In yet another embodiment, the high-pressure motive fluid can be greater than about 100 psi. In a further embodiment, the high-pressure motive fluid can be greater than about 200 psi. In an even further embodiment, the high-pressure motive fluid can be greater than about 500 psi. The high-pressure motive fluid can be any fluid source capable of operating the valve apparatus 10. In one embodiment, the high-pressure motive fluid can be natural gas captured from an oil and gas well.

As stated herein, the operational fluid of the contained environment or system (pressurized system 16) can have a certain pressure that has to be overcome by the high-pressure motive fluid forced operation of the valve apparatus 10 to be able to force the exhausted operation fluid from the compression cylinder 28. In one embodiment, the pressure of the pressurized system 16 and the operation fluid is greater than about 30 psi. In another embodiment, the pressure of the pressurized system 16 and the operation fluid is greater than about 45 psi. In yet another embodiment, the pressure of the pressurized system 16 and the operation fluid is greater than about 75 psi. In a further embodiment, the pressure of the pressurized system 16 and the operational fluid is greater than about 100 psi. In an even further embodiment, the pressure of the pressurized system 16 and the operation fluid is greater than about 200 psi. In yet an even further embodiment, the pressure of the pressurized system 16 and the operation fluid is greater than about 500 psi.

From the above description, it is clear that the present disclosure is well-adapted to carry out the objectives and to attain the advantages mentioned herein as well as those inherent in the disclosure. While presently preferred embodiments have been described herein, it will be understood that numerous changes may be made which will readily suggest themselves to those skilled in the art and which are accomplished within the spirit of the disclosure and claims.

What is claimed is:

1. A valve apparatus for controlling the flow of fluid, the valve apparatus comprising:
a valve having a valve body, a valve inlet for allowing fluid to flow into the valve body, and a valve outlet for allowing fluid to flow out of the valve body;
a rod element that selectively engages the valve to permit fluid to flow from the valve inlet to the valve outlet;
a valve actuation apparatus to apply force to the rod element to open and close the valve;
a spring disposed within the valve actuation apparatus for applying force to the rod element in a certain direction, the spring having a pressure force; and
a switch valve for selectively directing a high-pressure motive fluid to the valve actuation apparatus and for directing an operational fluid to the valve actuation apparatus.

2. The valve apparatus of claim 1 wherein the valve actuation apparatus includes a piston slidably disposed within a compression cylinder.

3. The valve apparatus of claim 1 wherein the high-pressure motive fluid has a pressure that is greater than the pressure force of the spring and a pressure of the operational fluid combined.

4. The valve apparatus of claim 3 wherein the switch valve directs the operational fluid to the top side and bottom side of the compression cylinder to equalize pressure above and below the piston and prevent the high-pressure fluid from entering the compression cylinder.

5. The valve apparatus of claim 4 wherein the switch valve directs the operational fluid to one of the top side or bottom side of the compression cylinder and directs the high-pressure fluid to the opposite side of the compression cylinder to open or close the valve.

6. The valve apparatus of claim 1 wherein the operational fluid is from a closed pressurized system having a pressure greater than about 30 psi.

7. The valve apparatus of claim 1 wherein the pressure of the high-pressure motive fluid is greater than about 50 psi.

8. The valve apparatus of claim 1 wherein the high-pressure motive gas is natural gas produced from an oil or gas well or gas from the casing of an oil or gas well.

9. The valve apparatus of claim 2 wherein the spring can be positioned on either side of the piston in the compression cylinder.

10. A method of opening a closing a valve using a high-pressure motive fluid, the method comprising:
directing a high pressure motive fluid to a valve apparatus to open and close a valve, the valve having a valve body, a valve inlet for allowing fluid to flow into the valve body, and a valve outlet for allowing fluid to flow out of the valve body;
directing an operation fluid to a valve apparatus to contribute to the opening and closing of the valve, the operational fluid taken from a contained pressurized system; and
exhausting the operational fluid from the valve apparatus back into the contained pressurized system under a pressure greater than about 30 psi.

11. The method of claim 10 wherein the valve apparatus further comprises:
a rod element that selectively engages the valve to permit fluid to flow from the valve inlet to the valve outlet;
a valve actuation apparatus to apply force to the rod element to open and close the valve;
a spring disposed within the valve actuation apparatus for applying force to the rod element in a certain direction, the spring having a pressure force; and
a switch valve for selectively directing the high-pressure motive fluid to the valve actuation apparatus and for directing the operational fluid to the valve actuation apparatus.

12. The method of claim 11 wherein the valve actuation apparatus includes a piston slidably disposed within a compression cylinder.

13. The method of claim 11 wherein the high-pressure motive fluid has a pressure that is greater than the pressure force of the spring and a pressure of the operational fluid combined.

14. The method of claim 13 wherein the switch valve directs the operational fluid to the top side and bottom side of the compression cylinder to equalize pressure above and below the piston and prevent the high-pressure fluid from entering the compression cylinder.

15. The method of claim 14 wherein the switch valve directs the operational fluid to one of the top side or bottom side of the compression cylinder and directs the high-pressure fluid to the opposite side of the compression cylinder to open or close the valve.

16. The method of claim 11 wherein the operational fluid is from a closed pressurized system having a pressure greater than about 45 psi.

17. The method of claim 11 wherein the pressure of the high-pressure motive fluid is greater than about 50 psi.

18. The method of claim 11 wherein the high-pressure motive gas is natural gas produced from an oil or gas well or gas from the casing of an oil or gas well.

19. The method of claim 12 wherein the spring can be positioned on either side of the piston in the compression cylinder.

20. The method of claim 11 wherein the valve apparatus further comprises a regulator to maintain the high-pressure motive fluid at a desired pressure.
